(19) United States
(12) Patent Application Publication
(10) Pub. No.: US 2019/0112170 A1
(43) Pub. Date: Apr. 18, 2019

(54) SHIPPING CASE WITH LIFT MECHANISM

(71) Applicant: Azure Biosystems, Inc., Dublin, CA (US)

(72) Inventors: Diping Che, San Ramon, CA (US); Zhefu Zhang, Beijing (CN)

(21) Appl. No.: 16/161,565

(22) Filed: Oct. 16, 2018

Related U.S. Application Data
(60) Provisional application No. 62/573,134, filed on Oct. 16, 2017.

(51) Int. Cl. B66F 7/06

(52) U.S. Cl. CPC B66F 7/0625; G01D 11/24; B66F 7/065

(57) ABSTRACT

The present disclosure provides cases comprising a lift mechanism, kits comprising a case and an instrument, and methods of using same.

### PRIORITY CLAIM

This application claims the benefit of U.S. Provisional Patent Application Ser. No. 62/573,134, filed Oct. 16, 2017, the entire contents of which are incorporated herein by reference and relied upon.

### BACKGROUND

Sensitive electronic instruments, such as imaging systems for detecting extremely small amounts of labeled analytes in an electrophoresis gel, frequently lose resolution when moved from one location to another. Minor adjustments in the instrument's location or environment can reduce sensitivity, damage fragile components, or even result in catastrophic failure. For those reasons and more, analyzers are often installed in a single location and never (or only very rarely) moved thereafter.

But an instrument's initial installed location may not be optimal for future use, such as when a laboratory undergoes renovations, expansions, contractions, or is even moved to a new location. In addition, immobile analyzer instruments require more expensive assets, like researchers and laboratory technicians, to move samples (which can often be fragile, inconvenience to move, or dangerous to handle for extended times) to the immobile instrument for analysis.

These inefficiencies and inconveniences therefore can cost a research organization time, money, and lost opportunities.

A need therefore continues to exist for a system for enabling safe movement of a sensitive laboratory instrument. The present disclosure meets this need.

### SUMMARY

The present disclosure provides a case comprising: (i) a base comprising a housing defined by a front wall, a rear wall, a first side wall, a second side wall and a floor; a cavity within the housing; and at least three casters attached to the floor; and (ii) a lid for mating with the base opposite the floor to enclose the cavity.

### BRIEF DESCRIPTION OF THE DRAWINGS

FIG. 1 shows a perspective view of a case for moving a sensitive instrument according to one embodiment of the present disclosure.

FIG. 2A shows a top perspective view of a case for moving a sensitive instrument with the lid removed according to one embodiment of the present disclosure.

FIG. 2B shows an electrical plug integrated into the base of a case for moving a sensitive instrument according to one embodiment of the present disclosure.

FIG. 2C shows a control switch integrated into the base of a case for moving a sensitive instrument according to one embodiment of the present disclosure.

FIG. 3 shows a partial see-through view of a case for moving a sensitive instrument with the lid removed according to one embodiment of the present disclosure.

FIG. 4 shows a kit comprising an instrument raised by a lift mechanism of a case for moving a sensitive instrument, wherein the lid has been removed, according to one embodiment of the present disclosure.

FIG. 5 shows a schematic view of a lift mechanism for use with a case according to one embodiment of the present disclosure.

FIG. 6A shows a perspective view of a case for moving a sensitive instrument with the lid removed and a lift mechanism in a retracted/stored position according to one embodiment of the present disclosure.

FIG. 6B shows a cutaway rear perspective view of a case for moving a sensitive instrument with the lid removed and a lift mechanism in a retracted/stored position according to one embodiment of the present disclosure.

FIG. 6C shows a cutaway front perspective view of a case for moving a sensitive instrument with the lid removed and a lift mechanism in a retracted/stored position according to one embodiment of the present disclosure.

FIG. 6D shows a cutaway perspective view of a case for moving a sensitive instrument and, specifically, a locking mechanism and shock absorbing mechanism integrated into a lift mechanism in a retracted/stored position according to one embodiment of the present disclosure.

FIG. 6E shows a cutaway perspective view of a case for moving a sensitive instrument and, specifically, a locking mechanism, shock absorbing mechanism, and sensor system integrated into a lift mechanism in a retracted/stored position according to one embodiment of the present disclosure.

FIG. 7A shows a perspective view of a case for moving a sensitive instrument with the lid removed and a lift mechanism in a deployed/operable position according to one embodiment of the present disclosure.

FIG. 7B shows a cutaway front perspective view of a case for moving a sensitive instrument with the lid removed and a lift mechanism in a deployed/operable position according to one embodiment of the present disclosure.

FIG. 7C shows a cutaway rear perspective view of a case for moving a sensitive instrument with the lid removed and a lift mechanism in a deployed/operable position according to one embodiment of the present disclosure.

FIG. 7D shows a cutaway perspective view of a case for moving a sensitive instrument and, specifically, a locking mechanism, shock absorbing mechanism, and sensor system integrated into a lift mechanism in a deployed/operable position according to one embodiment of the present disclosure.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

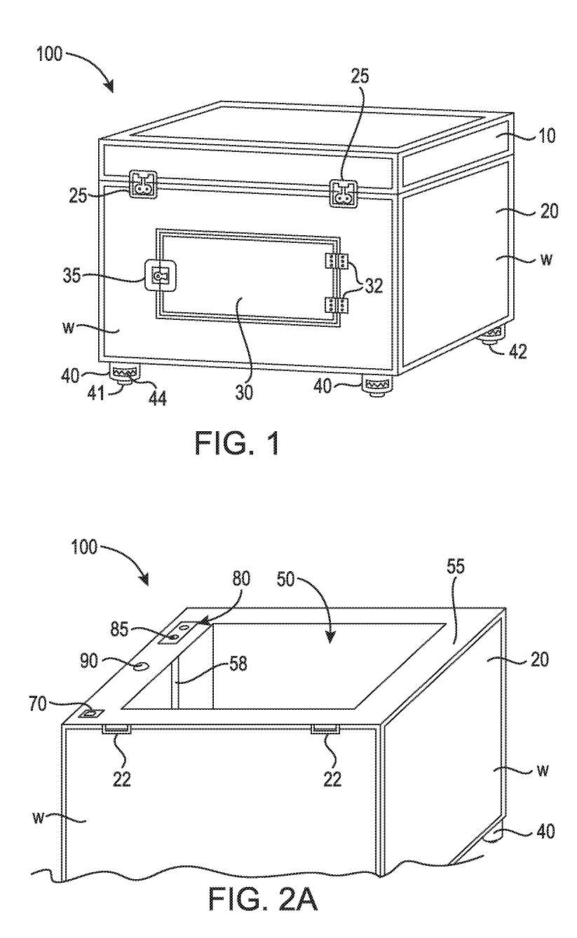

Referring generally to FIGS. 1-7D, the present disclosure provides a case for safely moving a sensitive instrument. Generally, the case 100 comprises a base 20 and a lid 10 that securely mates to the base 20 for transport. Inside the base 20 is a cavity 50 in which a lift platform 60 is disposed, the lift platform 60 configured to be raised or lowered within the cavity 50 to expose or hide, respectively, an electronic instrument I resting on or attached to the lift platform 60.

Referring now to FIG. 1, a case 100 comprises a base 20 and a lid 10 that mates to the base 20. In some embodiments, the lid 10 is secured to the base 20 by one or more latches 25. The lid 10 may be secured to the base 20 on one side by one or more hinges (not shown).

The base 20 may include four or more walls W and a floor F, each attached to a frame 21. At least one of the walls W may include a handle (not shown) for manipulating the case 100 during transport.

The base 20 may further include one or more, such as three or more, or four, casters 40. In some embodiments, the one or more casters 40 are connected to the frame 21 or to the floor F of the base 20 and enable the case 100 to be pushed or pulled across a surface.

The base 20 comprises side walls W and a frame 21 that are sturdy enough to provide support for an internal lift mechanism 200 (described in greater detail below), and to provide protection for an instrument I housed within the cavity 50 of the base 20 from impact by another object. The frame 21 must therefore be strong and also light to provide both protection for an included instrument I, and also to enable efficient shipping of the case 100. In some embodiments, the frame 21 comprises, consists essentially of, or consists of aluminum tubing, such and square or rectangular aluminum tubing. The tubing pieces may be connected to each other by any combination of welds, brackets, joints, etc. to provide a strong frame 21 that resists torsional stress, impact stress, compaction stress, vibrational stress, etc.

In some embodiments, the base 20 does not require disposable shipping padding (e.g., foam, packing peanuts, etc.) to provide ample protection to an instrument I housed within the cavity 50 during shipping.

In some embodiments, the base 20 includes a door 30 in one or more of the side walls W. The one or more doors 30 may be attached by any combination of hinges 32 and latches 35. Although the embodiment shown in FIG. 1 shows the door 30 attached to the side wall W using side-mounted hinges 32, the hinges 32 may attach the door 30 on any desirable edge. For example, in some embodiments, the hinges 32 may mount the door 30 so that when opened, the door 30 forms a horizontal shelf protruding from the side wall W of the base 20. In such an embodiment, the opened door 30 in horizontal shelf configuration may be used as a surface to, for example, place a keyboard or mouse or any other peripheral, a notebook, or a chemical reagent.

The one or more casters 40 enable convenient movement of the case 100 by a single person on most surfaces. In addition, the one or more casters 40 enable shipping equipment (e.g., a forklift) access to the bottom surface of the case 100 for lifting onto ships, trucks, airplanes, etc. The one or more casters 40 may include a wheel or spherical ball component 41, and a housing connecting the wheel or spherical ball component to the case 100. In some embodiments, at least one of the casters 40 further includes a lock mechanism 42 for reducing or eliminating the likelihood that the case 100 will be moved after transport is complete. In some embodiments, each of the one or more casters 40 includes a lock mechanism 42. In some embodiments, the lock mechanism 42 comprises a post or sleeve that can be extended to contact the surface on which the case 100 has been placed. For example, in the embodiment shown in FIG. 1, the casters 40 include a post 42 that can be lowered to contact the surface on which the case 100 has been placed by rotating a gear 44. In some embodiments, the one or more casters 40 comprise a centrally-positioned adjuster and an offset wheel (e.g., Carry Master K-92-600F, Misumi Corp., Japan).

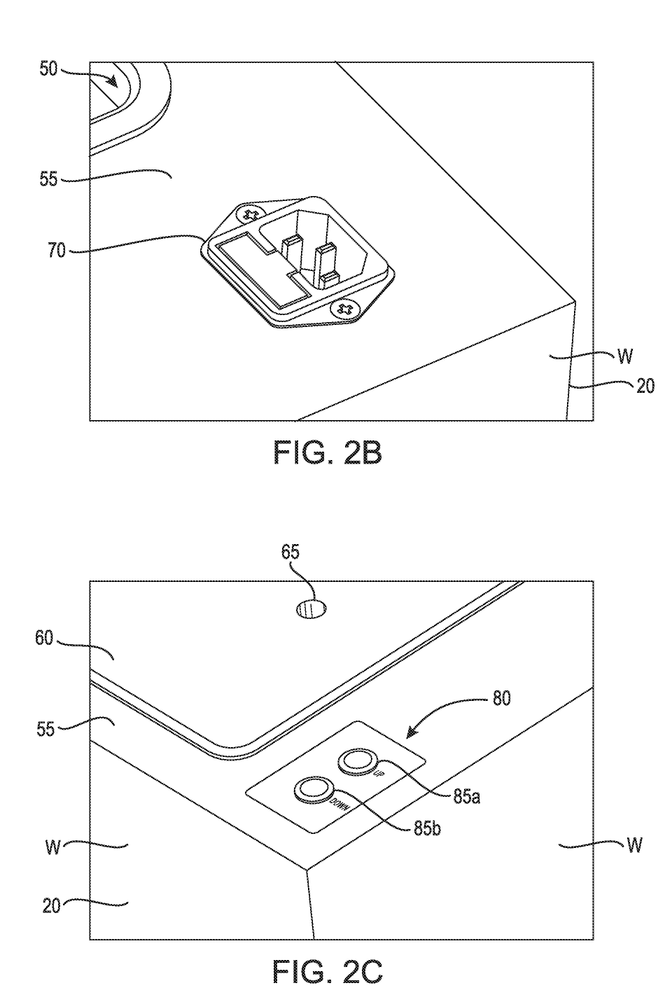

Referring now to FIGS. 2A-2C, a case 100 according to the present disclosure comprises a base 20 including one or more hinges 22 for mating with complementary hinges of a lid 10 (not shown). The base 20 defines a cavity 50 inside which an instrument I (not shown) may be stored. In some embodiments, the base 20 further includes a power socket 70, for example a power socket 70 integrated into an interior surface 55 of the base 20 that will be concealed by the lid 10 when mated with the base 20. In some embodiments, the power socket 70 accepts the same power cord as the instrument I stored within the cavity 50.

The lift platform 60 may be formed of any material sturdy enough to support a heavy instrument I. In some embodiments, the lift platform 60 is configured to support at least about 35 kg, for example at least about 35 kg, at least about 40 kg, at least about 45 kg, at least about 50 kg, at least about 55 kg, at least about 60 kg, at least about 65 kg, at least about 70 kg, at least about 75 kg, at least about 80 kg, at least about 85 kg, at least about 90 kg, at least about 95 kg, or at least about 100 kg. In some embodiments, the lift platform 60 is a steel plate. In other embodiments, the lift platform 60 is an aluminum platform.

In some embodiments, the lift platform 60 includes one or more mounting holes 65. In some embodiments, the one or more mounting holes 65 enable attachment of an instrument I to the lift platform 60, for example by passing the shafts of screws or bolts through the mounting hole(s) 65 from below the lift platform 60 and into the instrument I. In some embodiments, a shock absorber, such as a polymer cushion (e.g., a thick rubber washer) is placed between the lift platform 60 and the instrument I to further insulate the instrument I from impact during transportation.

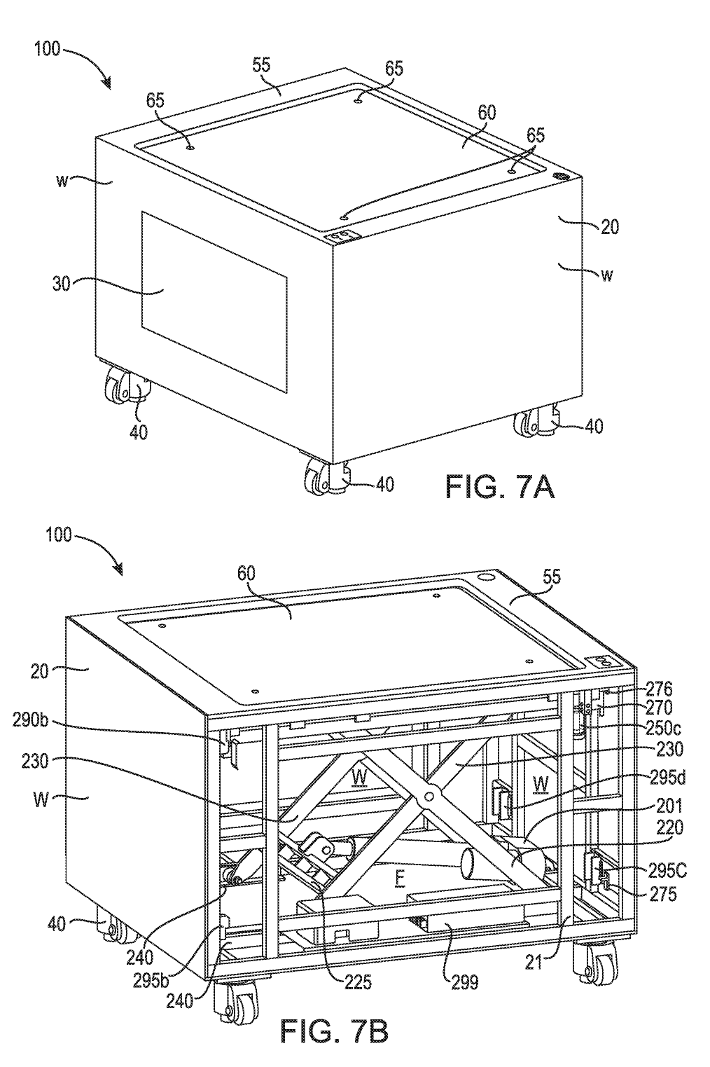

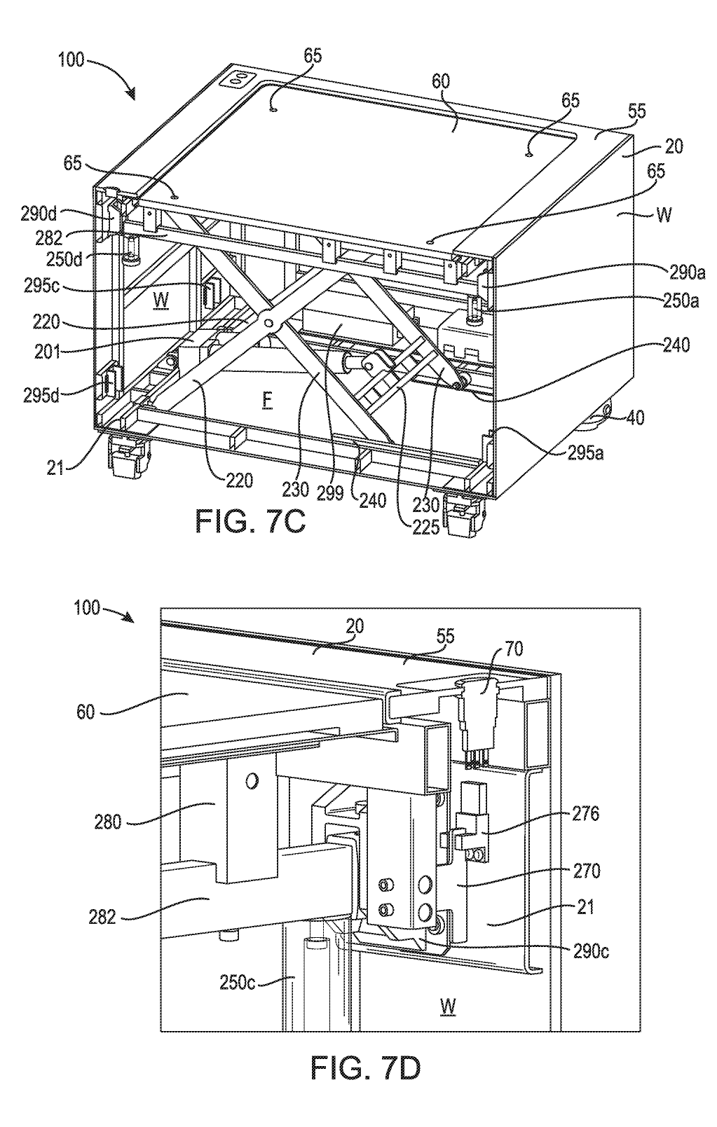

In some embodiments, the base 20 further comprises a lift platform control 80, which may include one or more switches 85a, 85b for controlling the direction, speed, and/or relative height of the lift platform 60 within the cavity 50. For example, the lift platform control 80 may include an “up” switch 85a which, when activated, causes the lift platform 60 to move upwards within the cavity 50, and a “down” switch 85b which, when activated, causes the lift platform 60 to move downwards within the cavity 50. A power supply 299 (see, e.g., FIGS. 7B-7C) may be in electrical communication with the power socket 70, the lift platform control 80, and the motor 201.

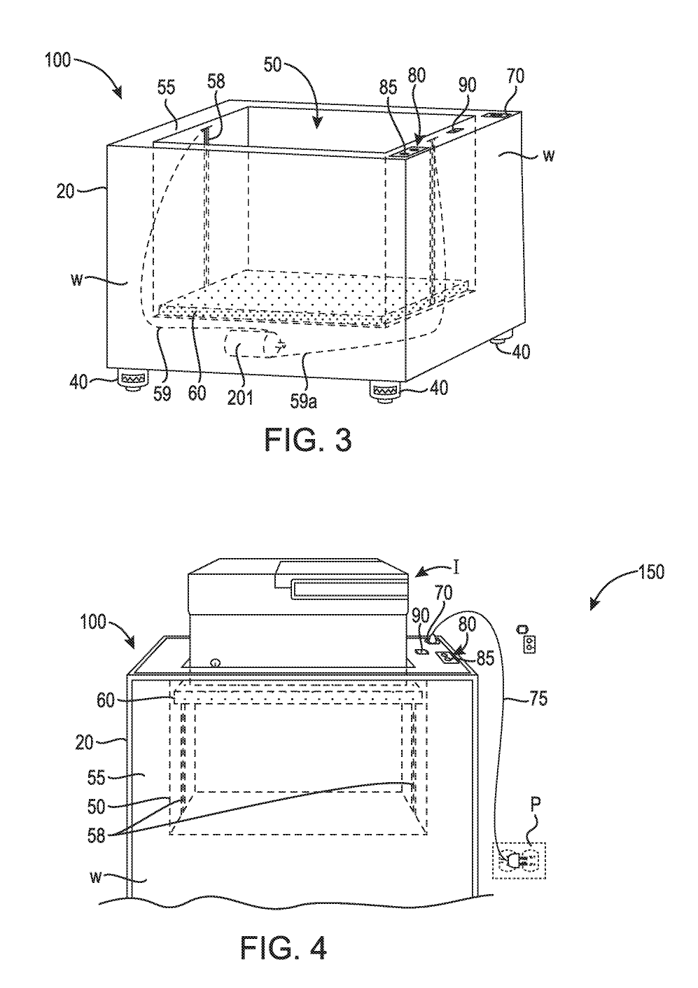

Referring now to FIG. 3, a case 100 according to one embodiment of the present disclosure comprises a base 20 comprising a cavity 50, inside which a lift platform 60 is disposed. The base 20 includes at least one vertical track 58 for guiding vertical movement of the lift platform 60. In some embodiments, such as the embodiment shown in FIG. 3, the one or more vertical tracks 58 may house a chain or rope 59a, 59b which may be attached to the lift platform 60 and to a motor 201 which, when activated by the lift control 80, causes the lift platform 60 to deploy vertically along the one or more tracks 58 to expose an instrument I resting on the platform (see FIG. 4).

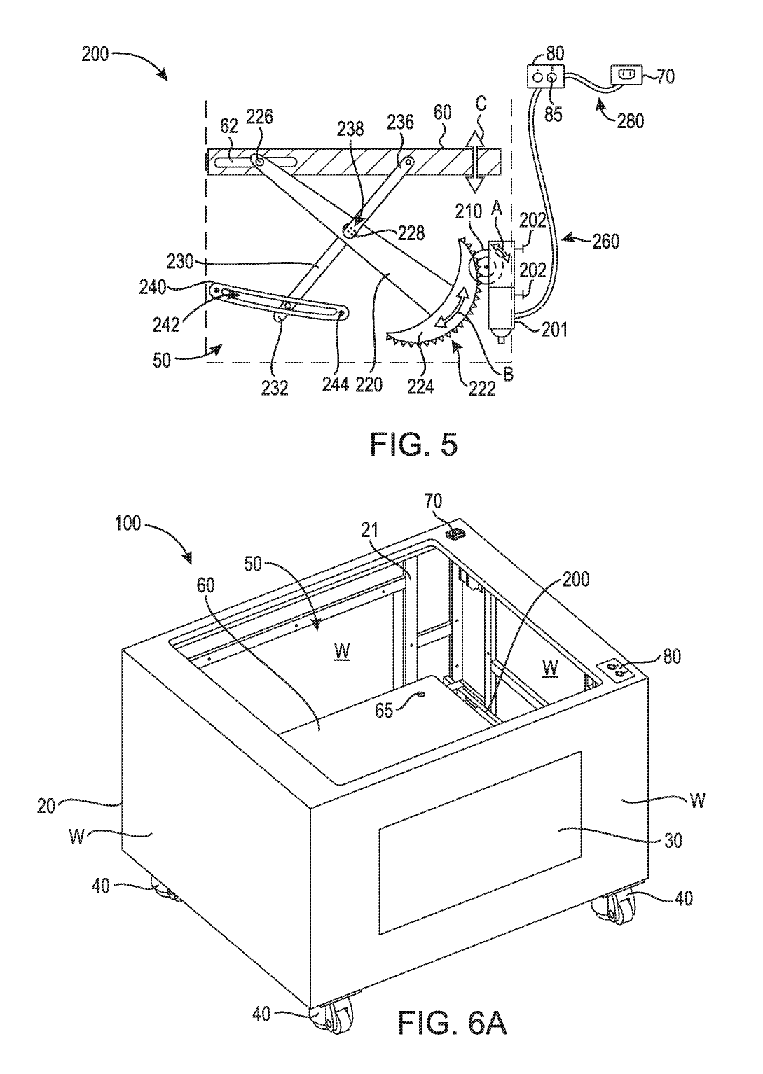

In other embodiments, such as the embodiment shown in FIG. 5, the motor 201 may instead be in mechanical communication with a geared head 224 of a first lever 220. For example, the motor 201 is secured to an inside surface of the case 20 at one or more anchor points 202, and may include a geared wheel 210. The geared wheel 210 is engaged with teeth 222 of the geared head 224 of the first lever 220, the distal end 226 of which may be engaged with a slot 62 in or on the platform 62. Activation of the motor 201 causes the geared wheel 210 to rotate (A) which causes the first lever 220 to rotate in the opposite direction (B) about a pivot 228. The pivot 228 may be engaged with a second lever 230 having a first end 232 engaged with a slot 242 of an anchor 240 that is attached to an inside surface of the case 20 at one or more anchor points 244, and a second pivoting end 236 that is secured to the lift platform 60. In such a configuration, the pivoting motion of the first lever 220 causes the second lever 230 to rotate in the opposite direction, which raises or lowers (C) the lift platform 60. In such embodiments, the motor 201 may be in electrical communication with the lift control 80 and the power socket 70 via wires 260, 280, respectively.

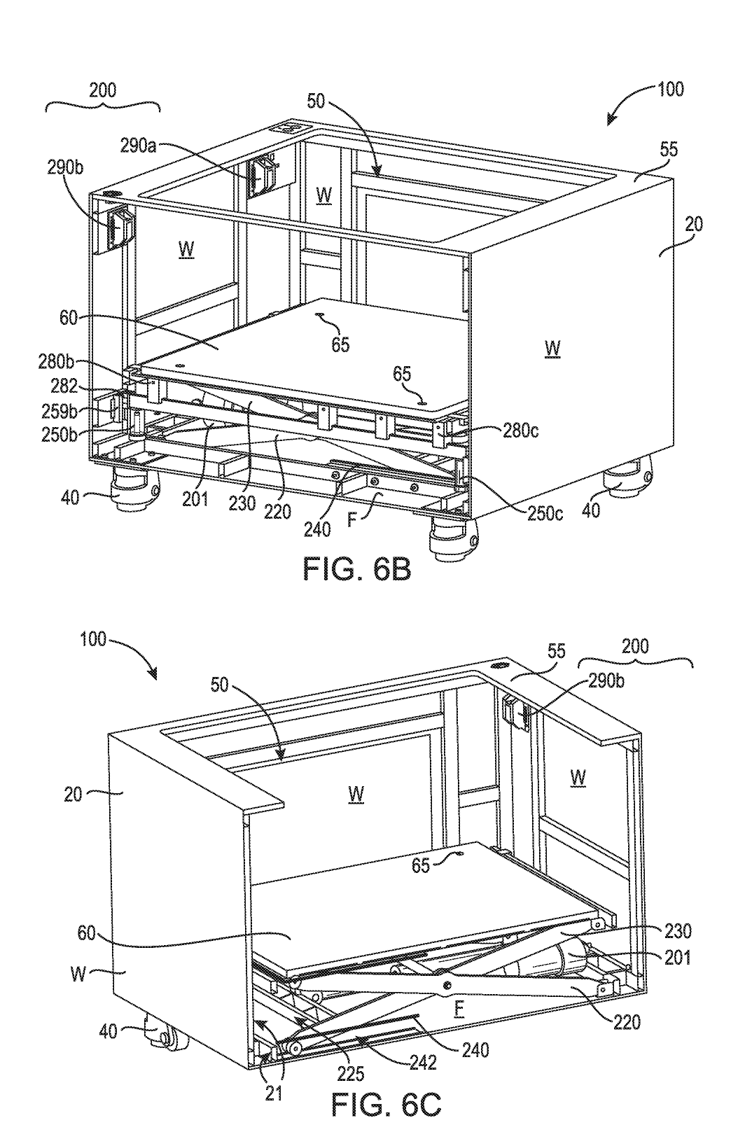

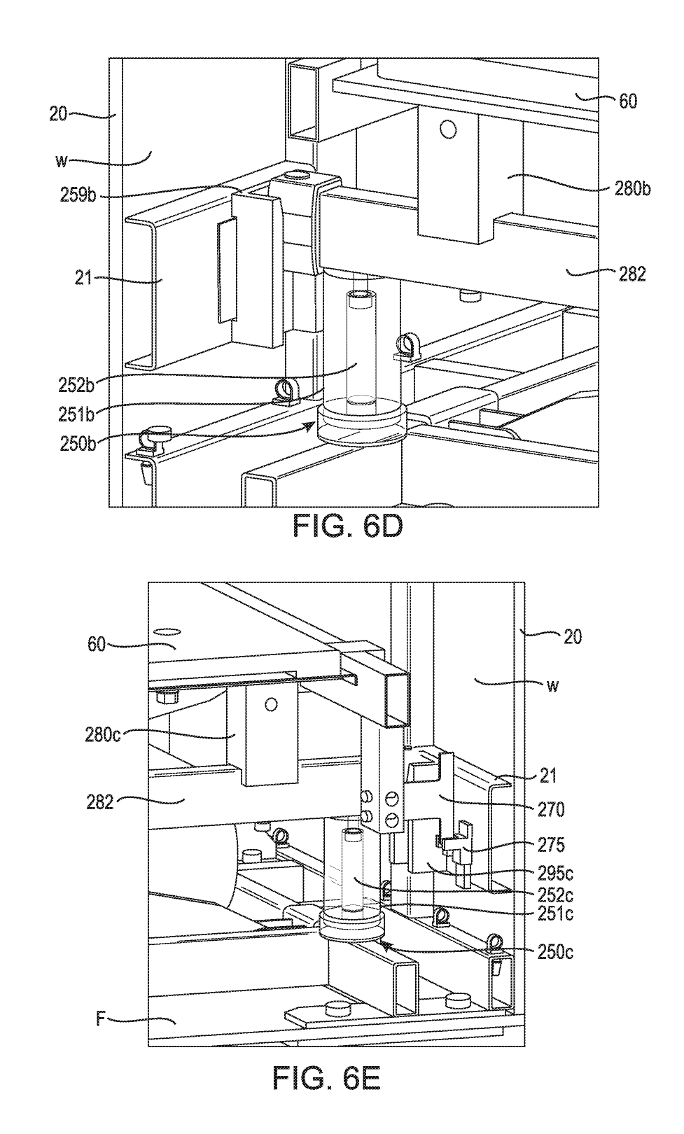

Referring now collectively to FIGS. 6A-7D, another embodiment of the present disclosure provides a case 100 comprising a base 20 defining a cavity 50 and including at least one caster 40. A lift platform 60 is housed within the cavity 50 and is attached to a lift mechanism 200. The lift mechanism 200 comprises one or more horizontal frame pieces 282 and optionally vertical frame pieces 280a, 280b, 280c, etc, and a brace 225. The lift mechanism 200 further comprises a linear actuator 201 including a housing that is attached to an inside surface of the base 20 and an actuator arm attached to the brace 225. A first lever 220 is attached near one end to the base 20, while the opposite end is slidably attached to the lift platform 60, for example using one or more tracks 240. A second lever 230 is attached near one end to the lift platform 60 (or to a frame piece 282, 280x, etc.), while the opposite end is slidably attached to the base 20, for example using one or more tracks 240. The first lever 220 and the second lever 230 are in pivotal communication with each other. In the embodiment shown in FIGS. 6A-7D, for example, the lift mechanism 200 comprises two matching sets of first levers 220 and second levers 230, one set at the front of the lift platform 60 and the other set at the back of the lift platform 60. Employment of a matching set of first levers 220 and second levers 230 may be advantageous when the load on the lift platform 60 is significant and/or unevenly balanced.

In operation, retraction of the actuator arm of the linear actuator 201 draws the distal slideable ends of the second levers 230 towards the proximal ends of the first levers 220, which pushes the lift platform 60 towards the top surface 55 of the base 20. Conversely, extension of the actuator arm of the linear actuator 201 pushes the distal slideable ends of the second levers 230 away from the stationary proximal ends of the first levers 220, causing the lift platform 60 to retract away from the top surface 55 of the base 20.

In some embodiments, the lift mechanism 200 further comprises one or more shock absorbers 250a, 250b, 250c, 250d, etc. The one or more shock absorbers 250a, 250b, 250c, 250d, etc. are in contact with the lift platform 60 when the lift platform 60 is in a retracted position (see, e.g., FIGS. 6B, 6D-6E) to absorb stimuli from the base 20 during transport. In some embodiments, the one or more shock absorbers 250a, 250b, 250c, 250d, etc., are mounted to the one or more horizontal frame pieces 282 or to the lift platform 60. In other embodiments, the one or more shock absorbers 250a, 250b, 250c, 250d, etc., are mounted to an inside surface of the base 20. In some embodiments, one or more shock absorbers 250a, 250b, 250c, 250d, etc., are mounted to an inside surface of the base 20, while one or more shock absorbers 250a, 250b, 250c, 250d, etc., are mounted to the one or more horizontal frame pieces 282 or to the lift platform 60. In some embodiments, the shock absorbers 250a, 250b, 250c, 250d, etc., comprise a piston 252a, 252b, 252c, 252d, etc., and a protective sleeve 251a, 251b, 251c, 251d, etc.

In some embodiments, the lift mechanism 200 further comprises one or more deployed locking mechanisms 290a, 290b, 290c, 290d, etc., for stabilizing the lift platform 60 when it is in a deployed/operable position. For example, as shown in FIGS. 7B-7D, one or more deployed locking mechanisms 290a, 290b, 290c, 290d, engage with a horizontal frame piece 282 when the lift platform 60 is in a deployed position (e.g., with the lift platform 60 at or near the top surface 55 of the base 20). In the embodiment shown in FIGS. 7B-7D, four deployed locking mechanisms 290a, 290b, 290c, 290d each engage with a portion of a horizontal frame piece 282 when the lift platform 60 is near the top surface 55 of the base 20.

In some embodiments, the lift mechanism 200 further comprises one or more retracted locking mechanisms 295a, 295b, 295c, 295d, etc., for stabilizing the lift platform 60 when it is in a retracted/stored position. For example, as shown in FIGS. 6B and 6D-6E, one or more retracted locking mechanisms 295a, 295b, 295c, 295d, engage with a horizontal frame piece 282 when the lift platform 60 is in a retracted position (e.g., with the lift platform 60 away from the top surface 55 of the base 20). In the embodiment shown in FIGS. 6B, 6D-6E, four retracted locking mechanisms 295a, 295b, 295c, 295d each engage with a portion of a horizontal frame piece 282 when the lift platform 60 is near the bottom of the base 20.

In some embodiments, the maximum retraction position of the lift platform 60 is determined by the length of the slots 242 in the one or more tracks 240. In other embodiments, the maximum retraction position of the lift platform 60 is determined instead by the positions of one or more retraction sensors 275. For example, as shown in FIG. 6E, in one embodiment a retraction sensor 275 positioned near the bottom of the base 20 is in electrical communication with the linear actuator 201 and causes the linear actuator 201 to stop extending the actuator arm when a tab 270 associated with the lift platform 60 (or with a horizontal frame piece 282 or a vertical frame piece 280a, 280b, 280c, 280d, etc.) engages with the retraction sensor 275. In some embodiments, the retraction sensor 275 is an optical gate. In another embodiment, the retraction sensor 275 comprises an electrical contact that is completed (or alternatively interrupted) when the tab 270 engages with the retraction sensor 275. In other embodiments, the retraction sensor 275 is a magnetic component that completes (or interrupts) a circuit when the tab 270 interacts with the retraction sensor 275. Incorporation of a retraction sensor 275 in the lift mechanism 200 enables more convenient adjustment of the maximum retraction position of the lift platform 60, and enables the case 100 to be used with instruments I of different dimensions.

In some embodiments, the maximum deployment position of the lift platform 60 is determined by the length of the slots 242 in the one or more tracks 240. In other embodiments, the maximum deployment position of the lift platform 60 is determined instead by the positions of one or more deployment sensors 276. For example, as shown in FIG. 7D, in one embodiment a deployment sensor 276 positioned near the top of the base 20 is in electrical communication with the linear actuator 201 and causes the linear actuator 201 to stop retracting the actuator arm when a tab 270 associated with the lift platform 60 (or with a horizontal frame piece 282 or a vertical frame piece 280a, 280b, 280c, 280d, etc.) engages with the deployment sensor 276. In some embodiments, the deployment sensor 276 is an optical gate. In another embodiment, the retraction sensor 275 comprises an electrical contact that is completed (or alternatively interrupted) when the tab 270 engages with the deployment sensor 276. In other embodiments, the deployment sensor 276 is a magnetic component that completes (or interrupts) a circuit when the tab 270 interacts with the deployment sensor 276. Incorporation of a retraction sensor 275 in the lift mechanism 200 enables more convenient adjustment of the maximum deployment position of the lift platform 60, and enables the case 100 to be used with instruments I of different dimensions.

In some embodiments, the present disclosure provides a case 100 comprising: (i) a base 20 comprising: a housing defined by a front wall W, a rear wall W, a first side wall W, a second side wall W and a floor F, a cavity 50 within the housing, and at least three casters 40 attached to the floor; and (ii) a lid 10 for mating with the base 20 opposite the floor F to enclose the cavity 50. In some embodiments, the case 100 further comprises a door 30 in at least one of the front wall W, the rear wall W, the first side wall W, or the second side wall W. In some embodiments, the case 100 further comprises shock absorbent material between the cavity 50 and each of the front wall W, the rear wall W, the first side wall W, the second side wall W, and the floor F. In some embodiments, the case 100 further comprises a lift platform 60 within the cavity. In some embodiments, the lift platform 60 is adjustably mounted within the cavity 50. In some embodiments, the lift platform 60 is adjustable in a vertical direction. In some embodiments, at least one of the casters 40 includes an adjustable leveler. In some embodiments, the case 100 further comprises a level indicator 90. In some embodiments, the case 100 further comprises a motor 201 operably connected to the lift platform 60. In some embodiments, the case 100 further comprises a switch 80 operably connected to the motor 201 for selectably adjusting the lift platform 60. In some embodiments, the case 100 further comprises a power supply unit 299 operably connected to the motor 201. In some embodiments, the case 100 further comprises at least one vertical track 58 engaged with the lift platform 60, wherein the at least one vertical track 60 is for guiding vertical adjustment of the lift platform 60. In some embodiments, the lid 10 comprises a shock absorbing material. In some embodiments, the lid 10 is removable from the base 20. In some embodiments, the door 30 opens to form a shelf. In some embodiments, the cavity 50 is sized to contain an instrument I. In some embodiments, the case 100 further comprises at least one sensor 275/276 for determining a position of the lift platform 60. In some embodiments, the case comprises at least two sensors 275/276. In some embodiments, at least one sensor 275/276 comprises a photogate. In some embodiments, vertical movement of the lift platform 60 stops when the photogate is interrupted. In some embodiments, at least one sensor 275/276 comprises an electrical contact. In some embodiments, vertical movement of the lift platform 60 stops when an electrical circuit including the electrical contact sensor is completed. In some embodiments, the case 100 further comprises at least one locking bracket 290 for engaging with the lift platform 60 when the lift platform 60 is in a retracted position. In some embodiments, the case 100 further comprises at least one locking bracket 295 for engaging with the lift platform 60 when the lift platform 60 is in a deployed position. In some embodiments, the case 100 further comprises at least one shock absorber 250 for reducing movement of the lift platform 60 when the lift platform 60 is in a retracted position. In some embodiments, the case 100 comprises at least four shock absorbers 250. In some embodiments, at least one shock absorber 250 is connected to the lift platform 60. In some embodiments, at least one shock absorber 250 is connected to an inside surface of the base 20 or to the frame 21.

The present disclosure further provides kits 150 comprising a case 100 as described herein and an instrument I. The instrument I may be any instrument I that fits within the cavity 50. In some embodiments, the instrument I is an electronic instrument. In some embodiments, the instrument I is sensitive to physical shock. In some embodiments, the instrument I is inconvenient to transport; for example the instrument may be inconveniently large or heavy, and/or may require recalibration after being moved.

In some embodiments, the present disclosure provides a kit 150 comprising an instrument I housed within a case 100 as disclosed herein. In some embodiments, the instrument I is an electrophoresis imager. In some embodiments, the electrophoresis imager comprises a CCD sensor for imaging chemiluminescent and visible features of an electrophoresis gel.

In some embodiments, the instrument I is any heavy article that might require more than one person to lift out of a shipping crate that does not include a lift mechanism.

In some embodiments, the instrument I is an analytical instrument. In some embodiments, the instrument I is an absorbance reader. In some embodiments, the instrument I is a gel electrophoresis analyzer. In some embodiments, the instrument I is an Azure cSeries™ Imager (Azure Biosystems, Inc.; Dublin, Calif. USA). In some embodiments, the instrument I is an Azure Sapphire™ Biomolecular Imager (Azure Biosystems, Inc.; Dublin, Calif. USA). In some embodiments, the instrument I is an Azure Ao™ Absorbance Microplate Reader (Azure Biosystems, Inc.; Dublin, Calif. USA). In some embodiments, the instrument I is an Amersham Typhoon 5 Biomolecular Imager (GE Healthcare Life Sciences; Marlborough, Mass.). In some embodiments, the instrument I is a ChemiDoc MP Imaging System (Bio-Rad Laboratories, Inc.; Hercules, Calif.). In some embodiments, the instrument I is an iBright Imaging System, such as an iBright FL1000 Imaging System or an iBright CL1000 Imaging System (Invitrogen/Life Sciences Technologies/ThermoFisher; Carlsbad, Calif.). In some embodiments, the instrument I is an Odyssey CLx Imaging System (LI-COR Biotechnology; Lincoln, Nebr.).

The present disclosure further provides methods for transporting an electronic instrument, such as a sensitive electronic instrument. In some embodiments, the method comprises transporting the electronic instrument in a case as described herein, deploying the lift platform of the case, and thereafter using the electronic instrument. In some embodiments, the method does not include calibrating the electronic instrument after deploying the lift platform.

In some embodiments, the present disclosure provides a method of transporting and preparing an electronic instrument for use, the method comprising: (i) arranging an electronic instrument on a lift platform of a case, the case further comprising: (a) a base comprising: a housing defined by a front wall, a rear wall, a first side wall, a second side wall and a floor; a cavity within the housing and within the lift platform may be adjusted in a vertical dimension; and at least three casters attached to the floor; and (b) a lid for mating with the base opposite the floor to enclose the cavity; (ii) lowering the electronic instrument into the cavity by adjusting the lift platform downward in a vertical direction; (iii) mating the lid with the base; (iv) transporting the case and included electronic instrument; (v) unmating the lid from the base; (vi) raising the electronic instrument from the cavity by adjusting the lift platform upward in a vertical direction; and (vii) optionally connecting the electronic instrument to a power supply. In some embodiments, the lift mechanism is in operable communication with a motor, and wherein the step of lowering the electronic instrument and/or the step of raising the electronic instrument further comprises connecting the motor to a power supply. In some embodiments, the method further comprises locking at least one caster after the step of transporting the case and included electronic instrument. In some embodiments, the step of arranging the electronic instrument comprises attaching the electronic instrument to the lift platform. In some embodiments, at least one caster includes a height adjuster, and wherein the method further comprises leveling the case using the at least one caster including the height adjuster. In some embodiments, the case is consistent with the embodiment shown in FIG. 1. In some embodiments, the case is consistent with the embodiment shown in FIG. 2A. In some embodiments, the case is consistent with the embodiment shown in FIG. 2B. In some embodiments, the case is consistent with the embodiment shown in FIG. 2C. In some embodiments, the case is consistent with the embodiment shown in FIG. 3. In some embodiments, the case is consistent with the embodiment shown in FIG. 4. In some embodiments, the case is consistent with the embodiment shown in FIG. 5. In some embodiments, the case is consistent with the embodiment shown in FIGS. 6A-7D. In some embodiments, the method further comprises using the electronic instrument after the step of raising the electronic instrument without calibrating the electronic instrument after the step of transporting the case and included electronic instrument.

### EXAMPLES

Aspects of embodiments may be further understood in light of the following examples, which should not be construed as limiting in any way.

### Example 1

A case 100 includes a base 20 and a mating lid 10. The base 20 comprises a frame 21 comprising square aluminum tubing that is surrounded by four vertical walls and a floor. The outside dimensions of the case 100 measure approximately 978 cm wide by 813 cm deep by 813 cm tall, excluding casters. Four locking casters (K-92-600F; Takigen, Tokyo, Japan) are mounted to the floor of the base 20. A lift platform 60 is housed within a cavity 50 defined by the four vertical walls and the floor of the base 20. The lift platform 60 is mechanically connected to a lift mechanism including a linear actuator 201 (BML-24-11-200-450-0; Beijing Manna Luck Tech-develop Co., LTD, China). The linear actuator 201 is in electrical communication with a power supply (SP-320-24; Meanwell; Wugu, Taiwan) and two switches 85 (PV6F240SS-341; E-Switches; Minneapolis, Minn.).

Without an included instrument I, the case 100 weighs approximately 50 kg.

An instrument I, such as an Azure Sapphire Biomolecular Imager (e.g., Azure Sapphire RGBNIR; Azure Biosystems, Inc.; Dublin, Calif.), which measures 75 cm wide, 45 cm tall and 70 cm deep and weighs about 70 kg, is attached to the lift platform 60 by four screws passed through mounting holes 65 in the lift platform 60 and into four threaded holes in the base of the instrument I.

In operation, a user removes the lid 10 from the base 20, then plugs the power supply 299 into an electrical source, such as a wall outlet. The user then presses the “up” switch 85 to cause the linear actuator 201 to retract its extendable arm, which in turn causes the lift mechanism 200 to raise the lift platform 60 within the cavity 50. The power supply 299 may then be disconnected from the power source, and the included instrument I used in normal operation, optionally without requiring recalibration of the instrument I.

When use of the instrument I is complete, the user disconnects the instrument I from any power source and external equipment (e.g., computer(s), monitor(s) and/or peripheral(s) connected to the instrument I by cables), then presses the “down” switch 85 which causes the linear actuator 201 to extend its extendable arm. This in turn causes the lift mechanism 200 to lower the lift platform 60 within the cavity 50. When the lift platform 60 has dropped to a suitable level, the lid 10 may then be re-mated with the base 20. The case 100 is then ready for relocation with minimal risk of damage to the instrument I.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

It is to be understood that both the foregoing descriptions are exemplary and explanatory only, and are not restrictive of the methods and devices described herein. In this application, the use of the singular includes the plural unless specifically stated otherwise. Also, the use of “or” means “and/or” unless stated otherwise. Similarly, “comprise,” “comprises,” “comprising,” “include,” “includes” and “including” are not intended to be limiting.

All patents, patent applications, publications, and references cited herein are expressly incorporated by reference to the same extent as if each individual publication or patent application was specifically and individually indicated to be incorporated by reference.

1: A case comprising:
a base comprising:
a housing defined by a front wall, a rear wall, a first side wall, a second side wall and a floor,
a cavity within the housing, and
at least three casters attached to the floor;
a lid for mating with the base opposite the floor to enclose the cavity; and
a lift platform within the cavity.

2: The case of claim 1 further comprising a door in at least one of the front wall, the rear wall, the first side wall, or the second side wall.

3: The case of claim 1 or claim 2 further comprising shock absorbent material between the cavity and each of the front wall, the rear wall, the first side wall, the second side wall, and the floor.

4. (canceled)

5: The case of claim 1, wherein the lift platform is adjustably mounted within the cavity, and is adjustable in a vertical direction.

6. (canceled)

7: The case of claim 1, wherein at least one of the casters includes an adjustable leveler.

8: The case of claim 1 further comprising a level indicator.

9: The case of claim 1 further comprising a motor operably connected to the lift platform, and a power supply unit operably connected to the motor.

10: The case of claim 9 further comprising a switch operably connected to the motor for selectably adjusting the lift platform.

11. (canceled)

12: The case of claim 9 further comprising at least one vertical track engaged with the lift platform, wherein the at least one vertical track is for guiding vertical adjustment of the lift platform.

13: The case of any one preceding claim, wherein the lid comprises a shock absorbing material.

14: The case of claim 13 wherein the lid is removable from the base.

15: The case of claim 2, wherein the door opens to form a shelf.

16: The case of claim 1, wherein the cavity is sized to contain an instrument.

17: The case of claim 1 further comprising at least one sensor for determining a position of the lift platform.

18. (canceled)

19: The case of claim 17, wherein the at least one sensor comprises a photogate.

20: The case of claim 19, wherein vertical movement of the lift platform stops when the photogate is interrupted.

21: The case of claim 17, wherein at least one sensor comprises an electrical contact.

22: The case of claim 21, wherein vertical movement of the lift platform stops when an electrical circuit including the electrical contact sensor is completed.

23: The case of claim 1 further comprising at least one locking bracket for engaging with the lift platform when the lift platform is in a retracted position, and at least one shock absorber for reducing movement of the lift platform when the lift platform is in a retracted position.

24: The case of claim 1 further comprising at least one locking bracket for engaging with the lift platform when the lift platform is in a deployed position.

25. (canceled)

26. (canceled)

27: The case of claim 25, wherein at least one shock absorber is connected to the lift platform.

28: The case of claim 25, wherein at least one shock absorber is connected to an inside surface of the base.

29-38. (canceled)
